(19) United States
(12) Patent Application Publication
(10) Pub. No.: US 2009/0141256 A1
(43) Pub. Date: Jun. 4, 2009

(54) Image Recording Method and Device

(75) Inventors: Issei Suzuki, Kanagawa (JP); Katsuto Sumi, Kanagawa-ken (JP); Kazuteru Kowada, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Croporation, Tokyo (JP)

(21) Appl. No.: 11/887,360

(22) PCT Filed: Mar. 28, 2006
(86) PCT No.: PCT/JP2006/306358

§ 371 Date: Jan. 10, 2008

(30) Foreign Application Priority Data
Mar. 28, 2005 (JP) 2005-091674
May 31, 2005 (JP) 2005-159793

(51) Int. Cl. G03B 27/54

(52) U.S. Cl. 355/67

(57) ABSTRACT

A laser beam is detected by a photosensor and a changing quantity of the light quantity is calculated to correct the fluctuation of the status of an exposure apparatus due to lapse of time. The laser beam is also detected by a photosensor to calculate a changing quantity of a beam diameter, and based on the changing quantities, mask data is modified. Then exposure recording of an image by exposure heads is continued by using the modified mask data.

### TECHNICAL FIELD

The present invention relates to a method of and an apparatus (device) for recording an image on an image recording medium by controlling a plurality of recording components arrayed along the image recording medium depending on image data.

### BACKGROUND ART

FIG. 24 is a view illustrative of a process of manufacturing a printed wiring board. A substrate 2 with a copper foil 1 deposited thereon by evaporation or the like is prepared. A photoresist 3 made of a photosensitive material is pressed with heat against (laminated on) the copper foil 1. After the photoresist 3 is exposed to light according to a wiring pattern by an exposure apparatus, the photoresist 3 is developed by a developing solution. Then, the portion of the photoresist 3 which has not been exposed is removed. The copper foil 1 that is exposed by the removal of the photoresist 3 is etched away by an etching solution. Thereafter, the remaining photoresist 3 is peeled off by a peeling solution. As a result, a printed wiring board having the copper foil 1 left in the desired wiring pattern on the substrate 2 is manufactured.

There has been developed a spatial light modulator such as a digital micromirror device (DMD) or the like, for example, as the exposure apparatus for recording the wiring pattern on the photoresist 3 (see U.S. Pat. No. 5,132,723). The DMD comprises a number of micromirrors tiltably disposed in a grid-like array on SRAMs (memory cells). The micromirrors have respective surfaces with a highly reflective material such as aluminum or the like being evaporated thereon. When a digital signal representative of image data is written into SRAM cells, the corresponding micromirrors are tilted in a given direction depending on the digital signal, selectively turning on and off light beams and directing the turned-on light beams to the photoresist 3 to record a wiring pattern by exposure.

The light beams reflected by the respective micromirrors and led to the photoresist 3 may have different intensities, beam diameters, beam shapes, etc., depending on the location. On the substrate 2 where the wiring pattern is to be formed, the laminated state of the photoresist 3 may differ depending on the location due to irregularities of heating temperature and pressure, and chemical reaction rates may become irregular in chemical processes such as the developing process and the etching process. For these reasons, it may not be possible to form wiring patterns of desired line widths.

In order to obtain wiring patterns of desired line widths, it may be proposed to record a test pattern on the substrate 2 by way of exposure, perform developing, etching, and peeling processes thereon, and thereafter measuring the test pattern to adjust the amount of light.

However, adjusting the amount of light requires extremely complex time-consuming processes, i.e., the developing, etching, and peeling processes. The exposure apparatus tends to suffer a reduction in the amount of light and a locality change in the amount of light due to light source aging, and a focus shift due to a fluctuation in the installed position of the optical system. Therefore, the exposure apparatus needs to be adjusted at an appropriate time in view of such time-depending changes.

### DISCLOSURE OF THE INVENTION

It is an external general object of the present invention to provide a method of and an apparatus for recording a desired image highly accurately on an image recording medium by performing an adjusting process with utmost ease against time-depending changes of the apparatus.

A major object of the present invention is to provide a method of and an apparatus for recording an image without causing a reduction in the accuracy of the image due to time-depending changes of the apparatus.

### BRIEF DESCRIPTION OF THE DRAWINGS

FIG. 1 is an external perspective view of an exposure apparatus according to an embodiment of the present invention;

FIG. 2 is a view illustrative of a characteristic value measuring means disposed in the exposure apparatus according to the embodiment;

FIG. 3 is a schematic view of an exposure head of the exposure apparatus according to the embodiment;

FIG. 4 is an enlarged fragmentary view showing a DMD employed in the exposure head shown in FIG. 3;

FIG. 5 is a view illustrative of an exposure recording process performed by the exposure head shown in FIG. 3;

FIG. 6 is a diagram showing the DMD of the exposure head shown in FIG. 3 and mask data set in the DMD;

FIG. 7 is a diagram showing the relationship between a recording position and an amount-of-light locality in the exposure apparatus according to the embodiment;

FIG. 8 is a diagram showing a line width recorded when the amount-of-light locality shown in FIG. 7 is not corrected;

FIG. 9 is a diagram showing a line width recorded when the amount-of-light locality shown in FIG. 7 is corrected;

FIG. 10 is a block diagram of a control circuit of the exposure apparatus according to the embodiment;

FIG. 11 is a flowchart of a process of generating mask data which is performed by the exposure apparatus according to the embodiment;

FIG. 12 is a diagram showing a test pattern recorded on a substrate by the exposure apparatus according to the embodiment;

FIG. 13 is a diagram showing the relationship between the positions of the test pattern shown in FIG. 12 and measured line widths;

FIG. 14 is a diagram showing the relationship between amounts of change in the amount of light of laser beams applied to the substrate and corresponding amounts of change in line widths;

FIG. 15 is a diagram showing the relationship between the position of the substrate and the amount-of-light correction variables;

FIG. 16 is a diagram showing the relationship between amounts of change in the beam diameters of laser beams applied to the substrate and corresponding amounts of change in line widths;

FIG. 17 is a diagram illustrative of a halftone dot pattern recorded on a substrate by the exposure apparatus according to the embodiment;

FIG. 18 is a diagram showing another test pattern recorded on a substrate by the exposure apparatus according to the embodiment;

FIG. 19 is a view showing an edge area formed along a direction in which a substrate is scanned;

FIG. 20 is a view showing an edge area formed along a direction perpendicular to a direction in which a substrate is scanned;

FIG. 21 is a diagram showing the relationship between amounts of change in the amounts of light and amounts of change in the light widths on photosensitive materials of different types;

FIG. 22 is a diagram showing the relationship between the position of the substrate and the line width on photosensitive materials of different types;

FIG. 23 is a diagram showing the relationship between the position of the substrate and the amount-of-light correction variables on photosensitive materials of different types; and

FIG. 24 is a view illustrative of a process of manufacturing a printed wiring board.

### BEST MODE FOR CARRYING OUT THE INVENTION

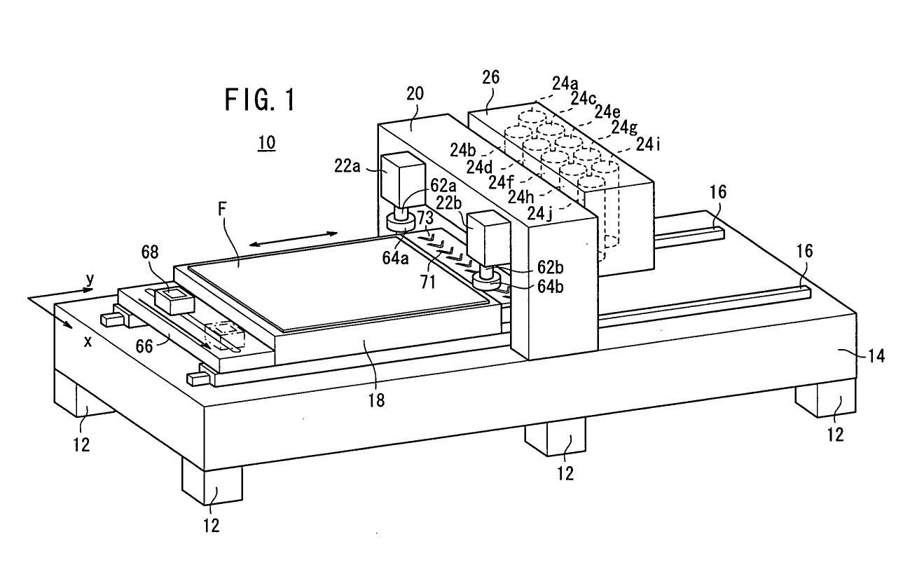

FIG. 1 shows an exposure apparatus 10 for performing an exposure process on a printed wiring board, etc., to which an image recording method and an image recording apparatus according to an embodiment of the present invention are applied. The exposure apparatus 10 has a bed 14, which suffers very little deformations, supported by a plurality of legs 12, and an exposure stage 18 mounted on the bed 14 by two guide rails 16 for reciprocating movement in the directions indicated by the arrow. An elongate rectangular substrate F (mage recording medium) coated with a photosensitive material is attracted to and held on the exposure stage 18.

A portal column 20 is mounted centrally on the bed 14 over the guide rails 16. Two CCD cameras 22a, 22b are fixed to one side of the column 20 for detecting the position in which the substrate F is mounted with respect to the exposure stage 18. A scanner 26 having a plurality of exposure heads 24a through 24j positioned and held therein for recording an image on the substrate F by way of exposure is fixed to the other side of the column 20. The exposure heads 24a through 24j are arranged in two staggered rows in a direction perpendicular to the directions in which the substrate F is scanned (the directions in which the exposure stage 18 is movable). Flash lamps 64a, 64b are mounted on the CCD cameras 22a, 22b, respectively, by respective rod lenses 62a, 62b. The flash lamps 64a, 64b apply an infrared radiation to which the substrate F is insensitive, as illuminating light, to an image capturing area for the CCD cameras 22a, 22b.

A guide table 66 which extends in the direction perpendicular to the directions in which the exposure stage 18 is movable is mounted on an end of the bed 14. The guide table 66 supports thereon a photosensor 68 (characteristic value measuring means) movable in the direction indicated by the arrow x for detecting the amount of light (image recording characteristic value) of laser beams L emitted from the exposure heads 24a through 24j.

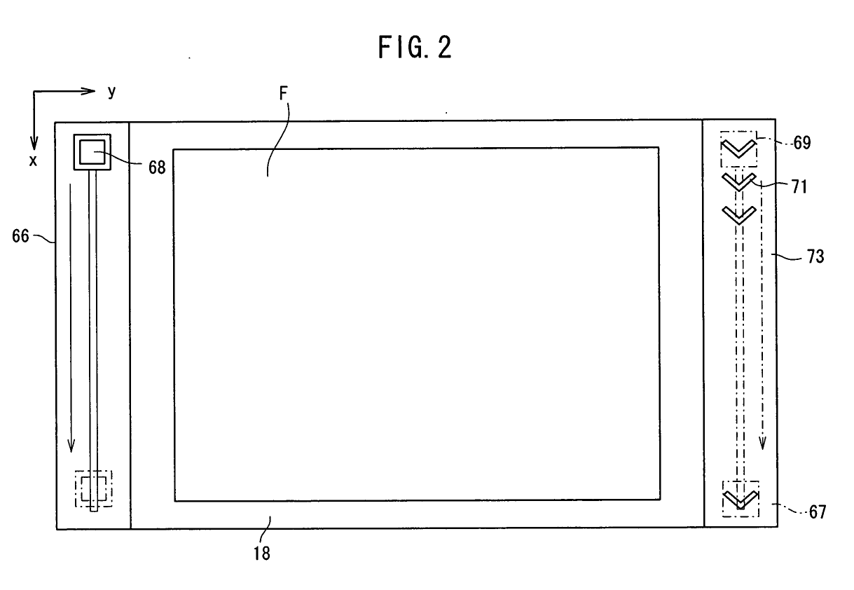

As shown in FIG. 2, a photosensor 69 (characteristic value measuring means) movable in the direction indicated by the arrow x along a guide table 67 is mounted on the other end of the bed 14. A slit plate 73 having a plurality of slits 71 arrayed in the direction indicated by the arrow x is disposed over the photosensor 69. Each of the slits 71 is V-shaped and comprises two slit sections inclined 450 to the directions in which the exposure stage 18 is movable (the direction indicated by the arrow y). The laser beams L that have passed through the slit sections of the slits 71 are detected by the photosensor 69, and beam diameters (image recording characteristic value) of the laser beams L are calculated from the positions of the exposure stage 18 at the time the laser beams L are detected by the photosensor 69.

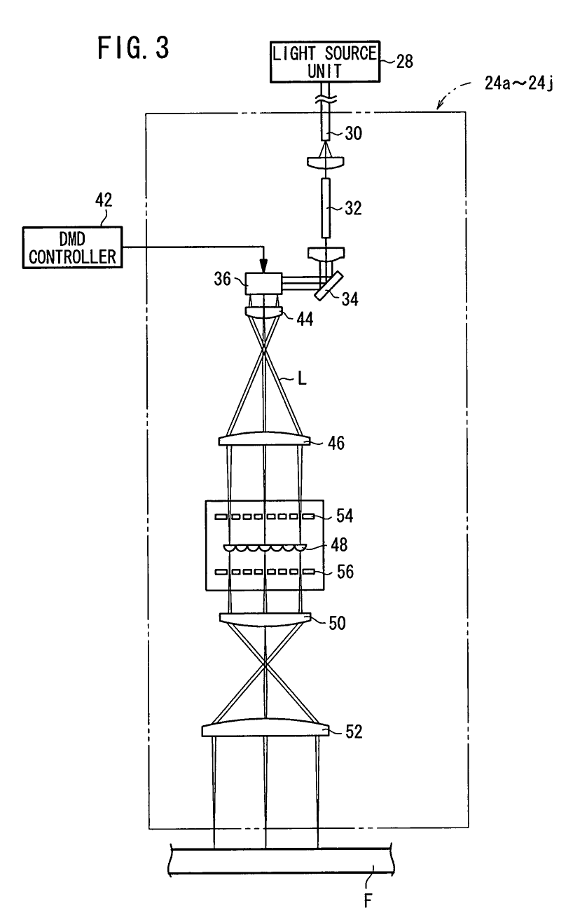

FIG. 3 shows a structure of each of the exposure heads 24a through 24j. A combined laser beam L emitted from a plurality of semiconductor lasers of light source unit 28 is introduced through an optical fiber 30 into each of the exposure heads 24a through 24j. A rod lens 32, a reflecting mirror 34, and a digital micromirror device (DMD) 36 are successively arranged on an exit end of the optical fiber 30 into which the laser beam L is introduced.

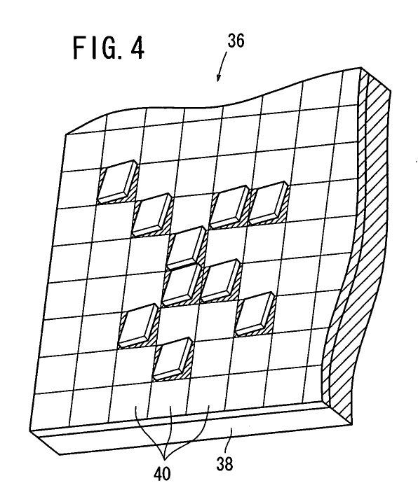

As shown in FIG. 4, the DMD 36 comprises a number of micromirrors 40 (recording components) that are swingably disposed in a grid-like pattern on SRAM cells (memory cells) 38. A material having a high reflectance such as aluminum or the like is evaporated on the surface of each of the micromirrors 40. When a digital signal according to image recording data is written in the SRAM cells 38 by a DMD controller 42, the micromirrors 40 are tilted in given directions depending on the applied digital signal. Depending on how the micromirrors 40 are tilted, the laser beam L is turned on or off.

In the direction in which the laser beam L reflected by the DMD 36 that is controlled to be turned on or off is emitted, there are successively disposed first image focusing optical lenses 44, 46 of a magnifying optical system, a microlens array 48 having may lenses corresponding to the respective micromirrors 40 of the DMD 36, and second image focusing optical lenses 50, 52 of a zooming optical system. Microaperture arrays 54, 56 for removing stray light and adjusting the laser beam L to a predetermined diameter are disposed in front of and behind the microlens array 48.

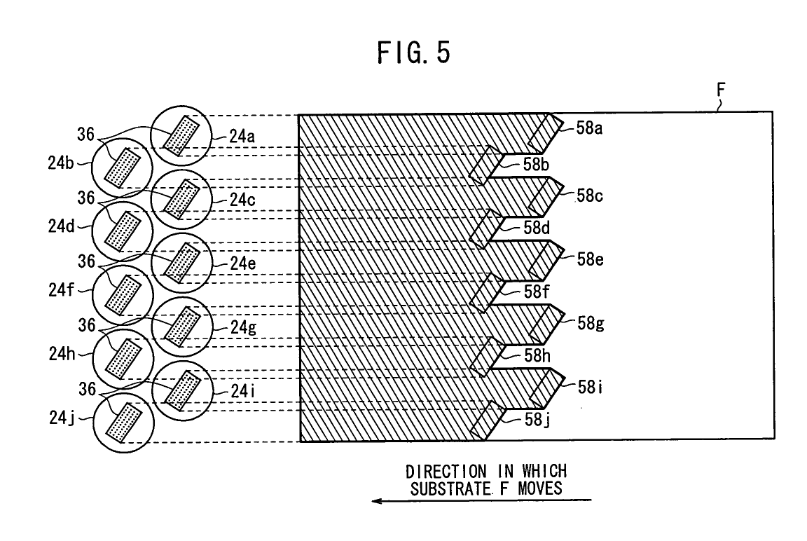

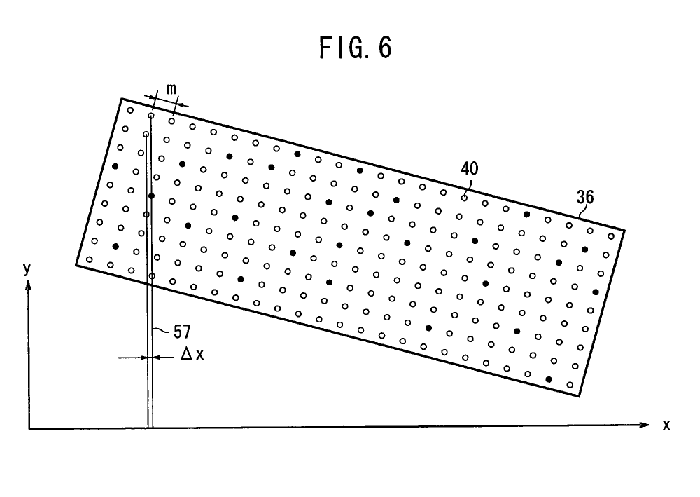

As shown in FIGS. 5 and 6, the DMDs 36 incorporated in the respective exposure heads 24a through 24j are inclined a predetermined angle to the direction in which the exposure heads 24a through 24j move, for achieving higher resolution. Specifically, the DMDs 36 that are inclined to the direction in which the substrate F is scanned (the direction indicated by the arrow y) reduce the interval Δx between the micromirrors 40 in the direction (the direction indicated by the arrow x) perpendicular to the direction in which the substrate F is scanned, to a value smaller than the interval m between the micromirrors 40 of the DMDs 36 in the direction in which they are arrayed, thereby increasing the resolution.

In FIG. 6, a plurality of micromirrors 40 are disposed on one scanning line 57 in the scanning direction of the DMDs 36 (the direction indicated by the arrow y). The substrate F is exposed to a multiplicity of images of one pixel by laser beams L that are guided to substantially the same position by these micromirrors 40. In this manner, amount-of-light irregularities between the micromirrors 40 can be averaged. To make the exposure heads 24a through 24j seamless, they are arranged such that exposure areas 58a through 58j which are exposed at a time by the respective exposure heads 24a through 24j overlap in the direction indicated by arrow x.

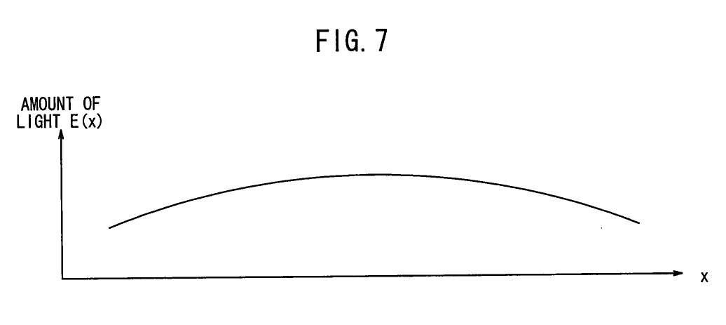

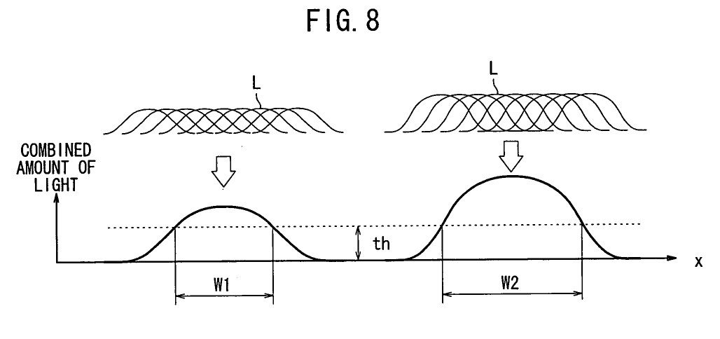

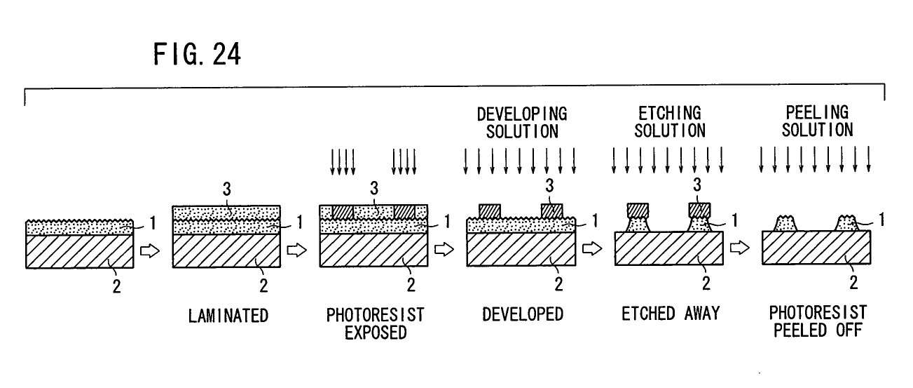

As shown in FIG. 7, the amount of light of the laser beam L that is guided to the substrate F by each of the micromirrors 40 of the DMDs 36 has a locality caused by the reflectance of the DMDs 36 along the direction indicated by the arrow x in which the exposure heads 24a through 24j are arrayed, and the state of the optical systems. With such a locality, as shown in FIG. 8, when an image is recorded on the substrate F by laser beams L having a smaller combined amount of light which are reflected by a plurality of micromirrors 40 and when an image is recorded on the substrate F by laser beams L having a greater combined amount of light which are reflected by the micromirrors 40, the images have respective different widths W1, W2 in the direction indicated by the arrow x which are determined by a threshold th beyond which the photosensitive material applied to the substrate F is sensitive to the laser beams L. When the exposed substrate F is processed by a developing process, an etching process, and a peeling process, as shown in FIG. 24, the widths of the images are also varied by photoresist lamination irregularities, developing process irregularities, etching process irregularities, and peeling process irregularities as well as the locality of the amount of light of the laser beams L. Furthermore, the exposure heads 24a through 24j and the light source unit 28 for introducing the laser beams L into the exposure heads 24a through 24j suffer time-dependent variations in their installed state and also time-dependent variations in the amounts of light of the laser beams L.

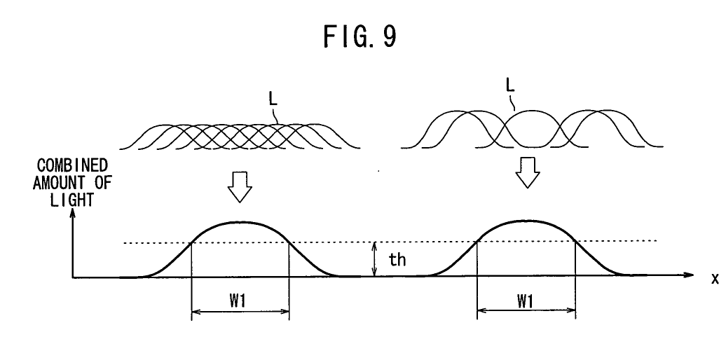

According to the present embodiment, in view of the above various factors responsible for the variations, the number of micromirrors 40 that are used to form one pixel of image on the substrate F is set and controlled using mask data, and the mask data is corrected at a desired time to produce images having a constant width W1, as shown in FIG. 9, regardless of the positions in the direction indicated by the arrow x taking the various processes to the final peeling process into consideration.

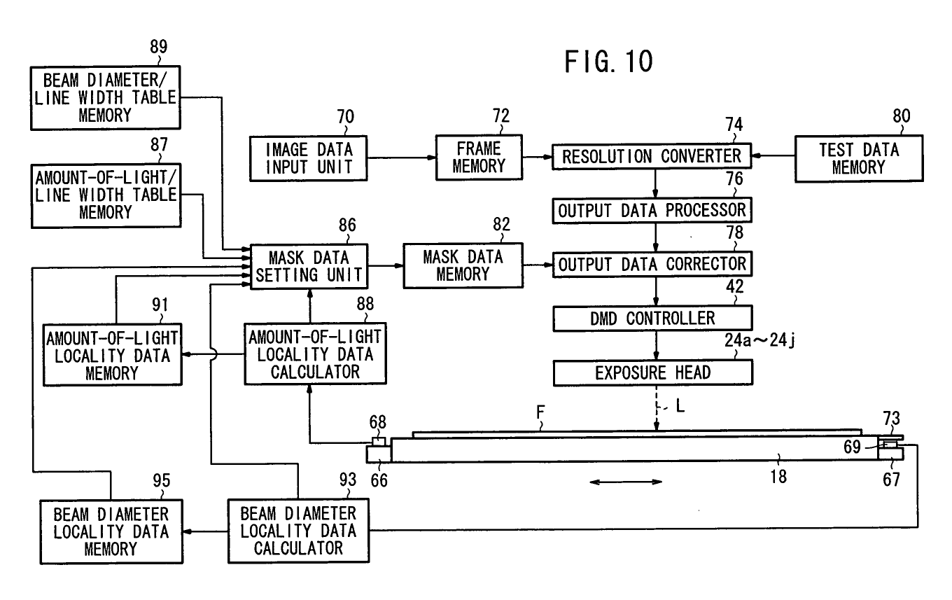

FIG. 10 shows in block form a control circuit of the exposure apparatus 10 having functions for performing such a control process.

The exposure apparatus 10 has an image data input unit 70 for entering image data to be recorded on the substrate F by exposure, a frame memory 72 for storing the entered two-dimensional image data, a resolution converter 74 for converting the resolution of the image data stored in the frame memory 72 into a higher resolution depending on the size and layout of the micromirrors 40 of the DMDs 36 of the exposure heads 24a through 24j, an output data processor 76 for processing the resolution-converted image data into output data to be assigned to the micromirrors 40, an output data corrector 78 for correcting the output data according to mask data, a DMD controller 42 (recording component control means) for controlling the DMDs 36 according to the corrected output data, and the exposure heads 24a through 24j for recording a desired image on the substrate F with the DMDs 36 that are controlled by the DMD controller 42.

A test data memory 80 for storing test data is connected to the resolution converter 74. The test data are data for recording by exposure a test pattern, which comprises a repetition of constant line widths and constant space widths, on the substrate F, and generating mask data based on the test pattern.

A mask data memory 82 (correction data storage means) for storing mask data is connected to the output data corrector 78. The mask data are data for specifying micromirrors 40 to be turned off at all times. The mask data are set by a mask data setting unit 86 (correction data setting means, amount-of-change calculating means, correction data correcting means).

Connected to the mask data setting unit 86, there are connected an amount-of-light/line width table memory (amount-of-change storage means) 87 for storing a data table representative of the relationship between amounts of change in amounts of light of the laser beams L and amounts of change in line widths of the test pattern due to the change in amounts of light, a beam diameter/line width table memory 89 (amount-of-change storage means) for storing a data table representative of the relationship between amounts of change in beam diameters of the laser beams L and amounts of change in line widths of the test pattern due to the amounts of change in beam diameters, an amount-of-light locality data calculator 88 for calculating amount-of-light locality data based on the amounts of light of the laser beams L detected by the photosensor 68, an amount-of-light locality data memory 91 for storing the amount-of-light locality data calculated by the amount-of-light locality data calculator 88, and a beam diameter locality data calculator 93 for calculating beam diameter locality data of the laser beams L.

The beam diameter locality data calculator 93 calculates beam diameters of the laser beams L and beam diameter locality data from the laser beams L detected by the photosensor 69 disposed on the exposure stage 18. The beam diameter locality data calculated by the beam diameter locality data calculator 93 are stored in a beam diameter locality data memory 95. The beam diameter locality data stored in a beam diameter locality data memory 95 are supplied to the mask data setting unit 86.

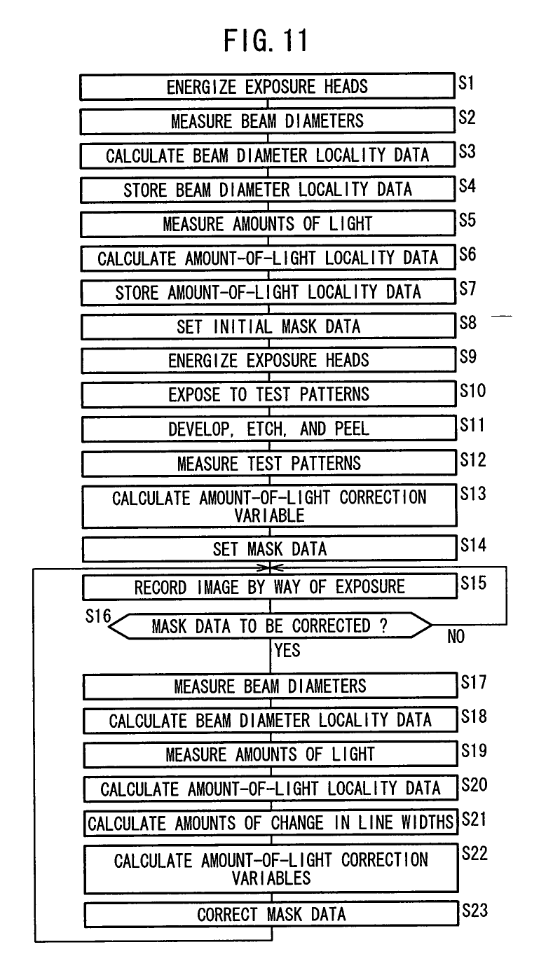

The exposure apparatus 10 according to the present embodiment is basically constructed as described above. A process of setting mask data will be described below with reference to FIG. 11.

First, the exposure stage 18 is moved to place the slit plate 73 and the photosensor 69 beneath the exposure heads 24a through 24j. Thereafter, the exposure heads 24a through 24j are energized to apply the laser beams L through the slits 71 of the slit plate 73 to the photosensor 69 (step S1).

The exposure stage 18 is moved in the direction indicated by the arrow y. The photosensor 69 detects the laser beams L at the time the laser beams L pass through one of the two slit sections of the slits 71 and at the time the laser beams L pass through the other of the two slit sections of the slits 71. The photosensor 69 supplies detected signals to the beam diameter locality data calculator 93, which measure beam diameters of the laser beams L from the detected signals (step S2).

As the photosensor 69 for detecting the laser beams L are moved in the direction indicated by the arrow x and the exposure stage 18 is moved in the direction indicated by the arrow y, the beam diameters of the laser beams L from the micromirrors 40 of the DMDs 36 of the exposure heads 24a through 24j are measured, and a distribution of the beam diameters in the direction indicated by the arrow x is calculated as beam diameter locality data (step S3). The calculated beam diameter locality data are stored in the beam diameter locality data memory 95 (step S4).

The exposure stage 18 is moved to place the photosensor 68 beneath the exposure heads 24a through 24j. While moving in the direction indicated by the arrow x in FIG. 1, the photosensor 68 measures the amounts of light of the laser beams L emitted from the exposure heads 24a through 24j, and supplies the measured amounts of light to the amount-of-light locality data calculator 88 (step S5). The amount-of-light locality data calculator 88 calculates a distribution of the measured amounts of light in the direction indicated by the arrow x as amount-of-light locality data (step S6). The calculated amount-of-light locality data is stored in the amount-of-light locality data memory 91 (step S7).

The amount-of-light locality data calculated by the amount-of-light locality data calculator 88 are supplied to the mask data setting unit 86. Based on the supplied amount-of-light locality data, the mask data setting unit 86 generates initial mask data for making constant the amount E(x) of light of the laser beam L at each position x on the substrate F, and stores the initial mask data in the mask data memory 82 (step S8). The initial mask data are established as data for controlling some of a plurality of micromirrors 40 for forming one image pixel at each position x on the substrate F, into an off-state according to the amount-of-light locality data in order to eliminate the amount-of-light locality shown in FIG. 7, for example. In FIG. 6, those micromirrors 40 that have been set to the off-state by the initial mask data are illustrated as black dots.

After the initial mask data have been established, the exposure stage 18 is moved to place the substrate F beneath the exposure heads 24a through 24j, and the exposure heads 24a through 24j are energized based on test data (step S9).

The resolution converter 74 reads test data from the test data memory 80, converts the resolution of the test data into a resolution corresponding to the micromirrors 40 of the DMDs 36, and supplies the resolution-converted test data to the output data processor 76. The output data processor 76 processes the test data into test output data representing signals for selectively turning on and off the micromirrors 40, and supplies the test output data to the output data corrector 78. The output data corrector 78 forcibly turns off those test output data for the micromirrors 40 which positionally correspond to the initial mask data supplied from the mask data memory 82, and then supplies the corrected test output data to the DMD controller 42.

The DMD controller 42 selectively turns on and off the micromirrors 40 of the DMDs 36 according to the test output data that have been corrected by the initial mask data, thereby applying the laser beams L emitted from the light source unit 28 to the substrate F to record a test pattern by exposure on the substrate F (step S10). Since the test pattern is formed according to the test output data that have been corrected by the initial mask data, the test pattern is free of the amount-of-light locality of the laser beams L.

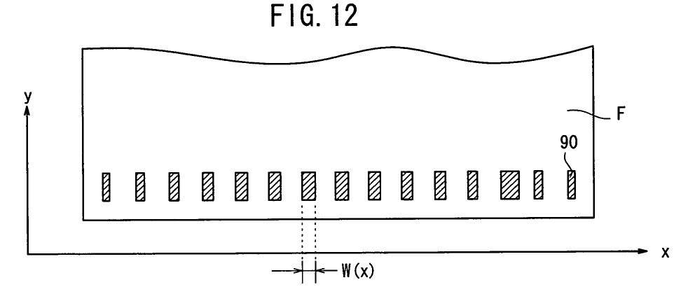

The developing process, the etching process, and the resist peeling process are performed on the substrate F with the test pattern recorded thereon by exposure, producing the substrate F with the test pattern remaining thereon (step S11). As shown in FIG. 12, for example, the test pattern comprises a plurality of rectangular test patterns 90 formed at respective positions x spaced along the direction indicated by the arrow x and having line widths W(x). In a locality-free ideal state, the test pattern is recorded based on test output data wherein the line widths W(x) and space widths are constant regardless of the position x.

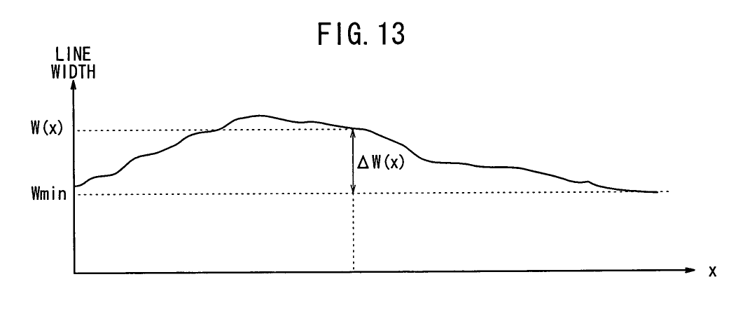

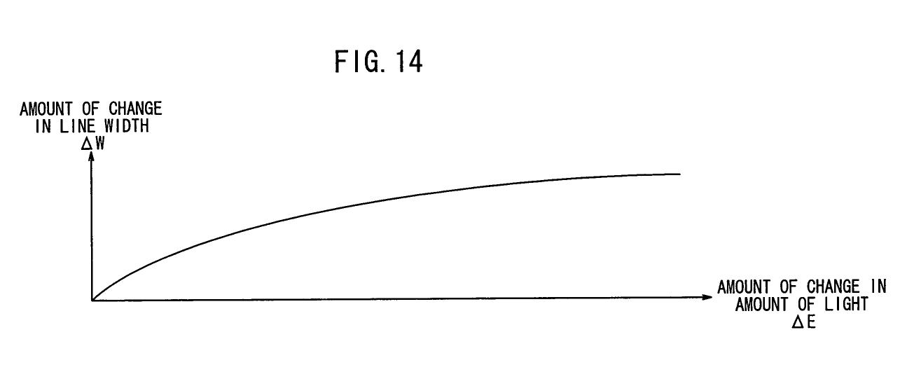

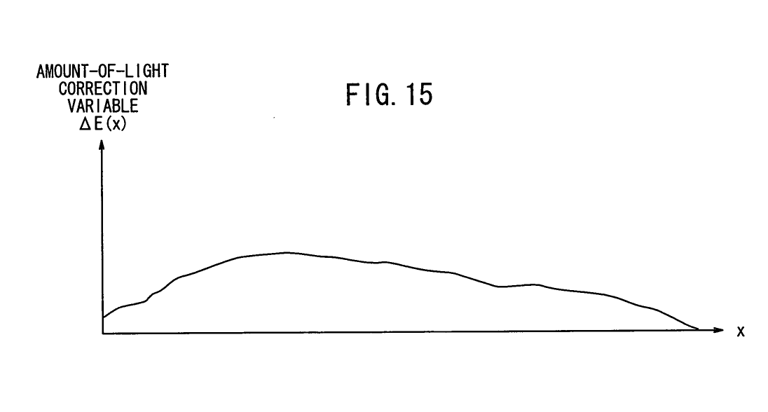

The line widths W(x) of the test patterns 90 on the substrate F are measured (step S12), and an amount-of-light correction variable ΔE(x) for correcting the line widths W(x) into a minimum line width Wmin is calculated (step S13). FIG. 13 shows the relationship between the positions x in the direction indicated by the arrow x and the measured line widths W(x). FIG. 14 shows the relationship between amounts ΔE of change in the amount of light of the laser beam L applied to the substrate F and corresponding amounts ΔW of change in the line widths. This relationship is determined in advance by an experiment, and stored in the amount-of-light/line width table memory 87. The amount-of-light correction variable ΔE(x) is calculated as an amount ΔE of change in the amount of light at each position x for obtaining an amount ΔW of change in the line width for turning the measured line width W(x) into a minimum line width Wmin, using the relationship shown in FIGS. 13 and 14 (see FIG. 15).

Based on the calculated amount-of-light correction variable ΔE(x), the mask data setting unit 86 adjusts the initial mask data set in step S8 to establish mask data (step S14). The mask data are established as data for determining micromirrors 40 to be set to the off-state among the micromirrors 40 that are used to form one pixel of image at each position x on the substrate F, according to the amount-of-light correction variables ΔE(x). The established mask data are stored, in place of the initial mask data, in the mask data memory 82.

Specifically, the mask data may be established as follows: Using the proportion of an amount-of-light correction variable ΔE(x) to an amount E(x) of light (see FIG. 7) at the time the output data are corrected with the initial mask data, and the number N of micromirrors 40 for forming one pixel, the number n of micromirrors 40 to be set to the off-state is calculated by:

n=N·ΔEi/Ei.

The mask data are established to set the n micromirrors 40, among the N micromirrors 40, to the off-state.

After the mask data have thus been established, a desired wiring pattern is recorded by way of exposure on the substrate F (step S15).

First, image data representing a desired wiring pattern are entered from image data input unit 70. The entered image data are stored in the frame memory 72, and then supplied to the resolution converter 74. The resolution converter 74 converts the resolution of the image data into a resolution depending on the resolution of the DMDs 36, and supplies the resolution-converted image data to the output data processor 76. The output data processor 76 calculates output data representing signals for selectively turning on and off the micromirrors 40 of the DMDs 36 from the resolution-converted image data, and supplies the calculated output data to the output data corrector 78.

The output data corrector 78 reads the mask data from the mask data memory 82, corrects the on- and off-states of the micromirrors 40 that are represented by the output data, using the mask data, and supplies the corrected output data to the DMD controller 42.

The DMD controller 42 energizes the DMDs 36 based on the corrected output data to selectively turn on and off the micromirrors 40. The laser beams L emitted from the light source unit 28 and introduced through the optical fibers 30 into the exposure heads 24a through 24j are applied via the rod lenses 32 and the reflecting mirrors 34 to the DMDs 36. The laser beams L selectively reflected in desired directions by the micromirrors 40 of the DMDs 36 are magnified by the first image focusing optical lenses 44, 46, and then adjusted to a predetermined beam diameter by the microaperture arrays 54, the microlens arrays 48, and the microaperture arrays 56. Thereafter, the laser beams L are adjusted to a predetermined magnification by the second image focusing optical lenses 50, 52, and then guided to the substrate F. The exposure stage 18 moves along the bed 14, during which time a desired wiring pattern is recorded on the substrate F by the exposure heads 24a through 24j that are arrayed in the direction perpendicular to the direction in which the exposure stage 18 moves.

After the wiring pattern has been recorded on the substrate F, the substrate F is removed from the exposure apparatus 10, and then the developing process, the etching process, and the peeling process are performed on the substrate F. The amount of light of the laser beam L applied to the substrate F has been adjusted in view of the processes up to the final peeling process based on the mask. Therefore, it is possible to obtain a highly accurate wiring pattern having a desired line width.

In the above embodiment, the test patterns 90 shown in FIG. 12 are recorded on the substrate F by way of exposure, and the mask data are determined by measuring the line widths W(x). However, mask data may be determined by measuring space widths between adjacent ones of the test patterns 90. If it is difficult to measure the line widths W(x) or the space widths highly accurately, then small areas may be established around the respective positions x of the test patterns 90 formed to have a constant density, the densities of the small areas may be measured, and mask data may be determined from a distribution of the measured densities.

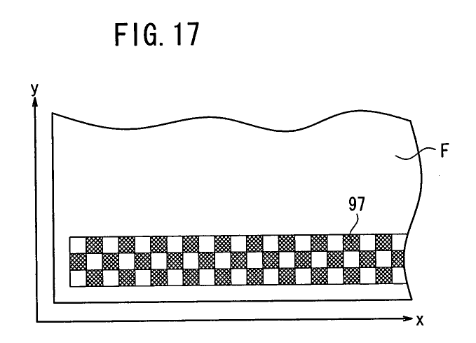

Instead of recording the test patterns 90 on the substrate F by way of exposure, as shown in FIG. 17, halftone dot patterns 97 having a predetermined halftone dot % may be recorded by way of exposure on the substrate F, and mask data may be determined by measuring halftone dot % or densities of the halftone dot patterns 97.

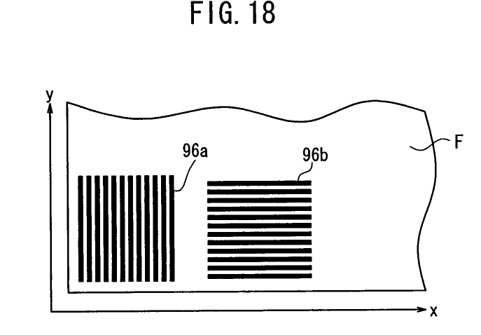

Instead of the test patterns 90, test patterns arranged in two different directions may be measured for line widths or spaced widths to determine mask data. For example, as shown in FIG. 18, a test pattern 96a of parallel bars along the scanning direction (the direction indicated by the arrow y) and a test pattern 96b of parallel bars along the line perpendicular to the scanning direction (the direction indicated by the arrow x) may be recorded in each position x on the substrate F, an amount-of-light correction variable may be calculated based on the average value of light widths of the test patterns 96a, 96b, and mask data may be determined. Using test patterns arranged in two different directions, it is possible to eliminate factors responsible for line width variations depending on the direction of the test patterns.

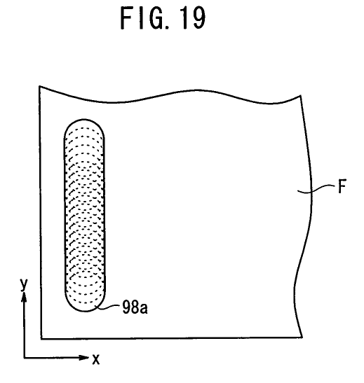

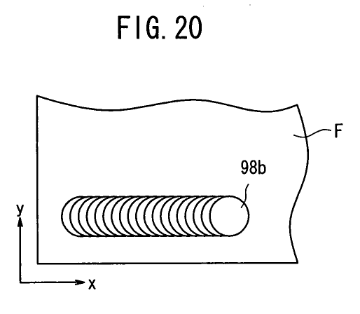

One factor that is responsible for varying the line widths may be that an edge of a test pattern is recorded differently in the scanning direction and the direction perpendicular to the scanning direction. Specifically, as shown in FIG. 19, an edge 98a of a test pattern in the direction in which the substrate F is scanned (the direction indicated by the arrow y), is recorded by a single spot or a plurality of spots of the laser beam L that move in the direction indicated by the arrow y, i.e., the direction in which the substrate F moves. On the other hand, as shown in FIG. 20, an edge 98b of a test pattern in the direction indicated by the arrow x is recorded by a plurality of spots of the laser beam L that do not move relatively to the substrate F. The difference as to how the edges 98a, 98b are recorded is possibly liable to develop different line widths. There is also a possibility of different line widths if the spots of the laser beam L are not of a circular shape.

Test patterns may be arranged in three or more directions, rather than the two directions described above. Test patterns that are inclined to the directions indicated by the arrows x, y may also be employed. A prescribed circuit pattern may be formed as a test pattern, and the circuit pattern may be measured to correct the amounts of light.

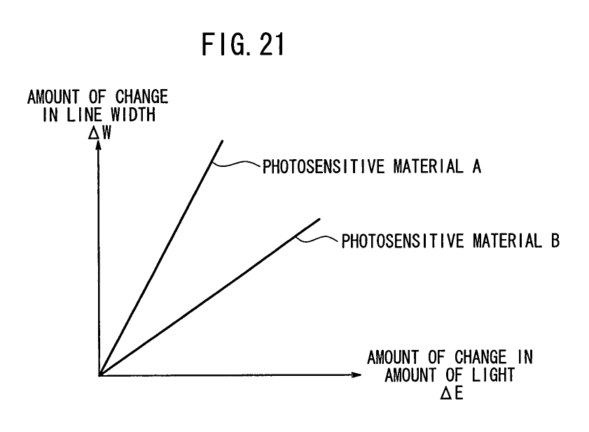

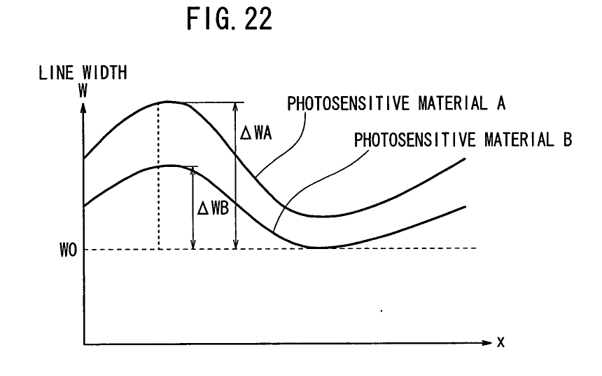

Alternatively, mask data may be established by determining an amount-of-light correction variable depending on the type of the photosensitive material applied to the substrate F. Specifically, as shown in FIG. 21, the relationship between an amount ΔE of change in the amount of light of the laser beam L applied to the substrate F and an amount ΔW of change in the line width, or the relationship between the amount of change in the beam diameter of the laser beam L and an amount ΔW of change in the line width, differs depending on the types of photosensitive materials A, B. The different relationships are caused by different gradation characteristics of the photosensitive materials A, B. As shown in FIG. 22, different line widths W may be produced even when a test pattern is recorded on the photosensitive materials A, B under the same conditions. In FIG. 21, the relationship between the amount ΔE of change in the amount of light and the amount ΔW of change in the line width is approximated by a straight line.

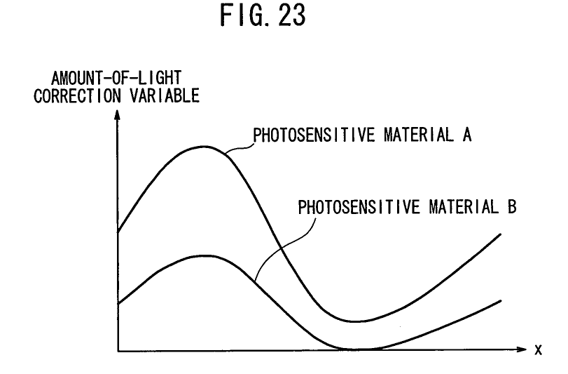

For recording patterns of the same line width regardless of the different characteristics of the photosensitive materials A, B, it is necessary to establish amount-of-light correction variables depending on the photosensitive materials A, B from the characteristic curves (FIG. 21) of the photosensitive materials A, B with respect to the relationship between the amount ΔE of change in the amount of light and the amount ΔW of change in the line width, and amounts of ΔWA, ΔWB (FIG. 22) of change in the line width from a reference line width W0 (e.g., a minimum value of the line width W) at each position x for the respective photosensitive materials A, B. FIG. 23 shows an example of amount-of-light correction variables established for the photosensitive materials A, B.

The localities of the amounts of light may be corrected based on the amounts of light, and the localities of the beam diameters may be corrected based on the beam diameters and the type of the photosensitive material. Alternatively, a table representing the relationship between beam diameters (amounts of light) and line widths may be prepared, and a locality correction variable may be determined by referring to the table based on the beam diameter (the amount of light).

According to the present embodiment, the mask data setting unit 86 sets mask data based on the amount-of-light correction variables that are determined for the photosensitive materials A, B, and stores the established mask data in the mask data memory 82. For exposing the substrate F to a desired wiring pattern, mask data corresponding to the type of the photosensitive material entered by the operator are read from the mask data memory 82, and output data supplied from output data processor 76 are corrected by the mask data. In this manner, a highly accurate wiring pattern free of line width variations can be recorded on the substrate F independently of the type of the photosensitive material.

If the states of the exposure heads 24a through 24j of the exposure apparatus 10, e.g., the positions where the exposure heads 24a through 24j are mounted on the column 20, the power and wavelength of the laser beams L emitted from the light source unit 28, and the focused positions of the laser beams L on the substrate F are varied, then a wiring pattern cannot be formed highly accurately. For coping with such time-dependent changes of the exposure apparatus 10, it is necessary to adjust the exposure apparatus 10 at suitable times.

According to the present invention, the exposure apparatus 10 can easily and automatically be adjusted to cope with time-depending changes by correcting mask data.

When instructed by the user or when the exposure apparatus 10 starts up, if a command for correcting mask data is entered (step S16), then the photosensor 69 fixed to one end of the exposure stage 18 is moved into the position beneath the exposure heads 24a through 24j, as with step S2. The photosensor 69 detects the laser beams L from the micromirrors 40 through the slit plate 73, and transmits detected signals to the beam diameter locality data calculator 93, which measures beam diameters (step S17). The beam diameter locality data calculator 93 calculates beam diameter locality data with respect to the direction indicated by the arrow x from the measured beam diameters, and supplies the calculated beam diameter locality data to the mask data setting unit 86 (step S18).

The photosensor 68 fixed to the other end of the exposure stage 18 is moved into the position beneath the exposure heads 24a through 24j. The photosensor 68 detects the amounts of light of the laser beams L from the micromirrors 40 (step S19), and transmits the detected signal to the amount-of-light locality data calculator 88, which calculates amount-of-light locality data and supplies the calculated amount-of-light locality data to mask data setting unit 86 (step S20).

The mask data setting unit 86 calculates amounts of change in the line widths W(x) of the test patterns 90 shown in FIG. 12 (amounts ΔW(x) of change in the line widths), using the beam diameter locality data supplied from the beam diameter locality data calculator 93, the amount-of-light locality data supplied from the amount-of-light locality data calculator 88, the beam diameter locality data from the preceding measurement cycle which is stored in the beam diameter locality data memory 95, and the amount-of-light locality data from the preceding measurement cycle which is stored in the amount-of-light locality data memory 91 (step S21).

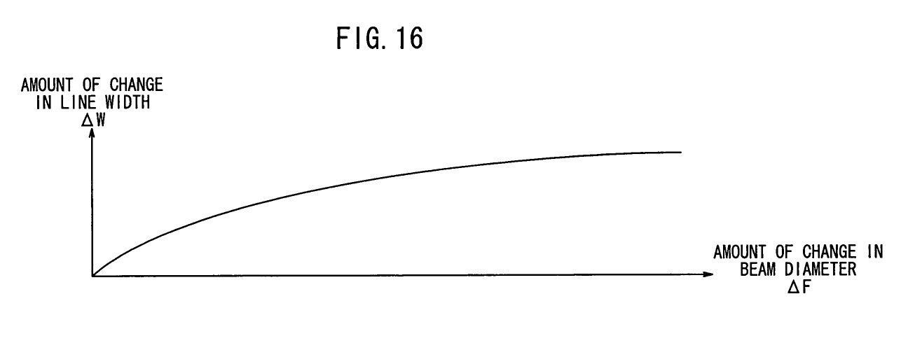

Specifically, amounts (ΔE(x)) of change in the amounts of light of the laser beams L and amounts (ΔF(x)) of change in the beam diameters of the laser beams L are considered as factors for varying the line widths W(x) of the test patterns 90. The relationship between the amounts (ΔE(x)) of change in the amounts of light and the amounts (ΔW(x)) of change in the line widths are stored in advance in the amount-of-light/line width table memory 87 (see FIG. 14). The relationship between the amounts (ΔF(x)) of change in the beam diameters and the amounts (ΔW(x)) of change in the line widths are stored in advance in the beam diameter/line width table memory 89 (see FIG. 16).

If amounts of change in the line widths with respect to amounts ΔE(x) of change in the amounts of light are represented by ΔW1(x) and amounts of change in the line widths with respect to amounts of change in the beam diameters are represented by ΔW2(x), then amounts Δ(x) of change in the line widths due to the amounts ΔE(x) of change in the amounts of light and the amounts (ΔF(x)) of change in the beam diameters are expressed by:

$$\begin{matrix}Δ W ( x ) = Δ W 1 ( x ) + Δ W 2 ( x ) \\ = f ( Δ E ( x ) ) + g ( Δ F ( x ) )\end{matrix}$$

where f is a function representative of the relationship between the amounts ΔW1(x) of change in the line widths and the amounts ΔE(x) of change in the amounts of light, e.g., the table stored in the amount-of-light/line width table memory 87, and g is a function representative of the relationship between the amounts ΔW2(x) of change in the line widths and the amounts (ΔF(x)) of change in the beam diameters, e.g., the table stored in the beam diameter/line width table memory 89. The functions f, g representative of the relationships between the amounts ΔE(x) of change in the amounts of light and the amounts (ΔF(x)) of change in the beam diameters, and the amounts ΔW(x) of change in the line widths may be established depending on the type of the photosensitive material applied to the substrate F.

The mask data setting unit 86 calculates an amount-of-light correction variable ΔEcor(x) for correcting the amounts ΔW(x) of change in the line widths, using the table stored in the amount-of-light/line width table memory 87, as follows:

ΔEcor(x)=f⁻¹(ΔW(x))

(step S22).

Then, based on the calculated amount-of-light correction variable ΔEcor(x), the mask data setting unit 86 corrects the present mask data stored in the mask data memory 82 (step S23), as is the case with the step S14. The corrected mask data are stored in the mask data memory 82, and a desired image is recorded by way of exposure using the new mask data (step S15).

Time-depending changes in the developing process, the etching process, and the peeling process after the exposure are considered to be smaller than time-depending changes in the state of the exposure apparatus 10. Therefore, desired wiring patterns can continuously be formed highly accurately by a simple process of measuring the amounts of light of the laser beams L and measuring the beam diameters thereof to correct the mask data, without the need for a tedious, time-consuming process of forming the test patterns 90 shown in FIG. 12 to establish mask data.

The image recording characteristic value indicative of time-depending changes in the state of the exposure apparatus 10 may be the focused position of the laser beams L with respect to the substrate F, rather than the beam diameters. Alternatively, a time-dependent positional shift of the laser beams L with respect to the substrate F may be detected as an image recording characteristic value, and the mask data may be corrected based on the detected value.

The exposure apparatus 10 may appropriately be used to expose a dry film resist (DFR) or a liquid resist in a process of manufacturing a multilayer printed wiring board (PWB), to form a color filter or a black matrix in a process of manufacturing a liquid crystal display (LCD), to expose a DFR in a process of manufacturing a TFT, and to expose a DFR in a process of manufacturing a plasma display panel (PDP), etc., for example. The present invention is also applicable to an image recording apparatus having an ink jet recording head. The present invention is also applicable to exposure apparatus for use in the field of printing and the field of photography.

1. A method of recording an image on an image recording medium by controlling a plurality of recording components depending on image data, comprising the steps of:
setting correction data for correcting a state in which the recording components are controlled by said image data;
measuring an image recording characteristic value provided by said recording components;
determining a time-dependent amount of change in said image recording characteristic value;
correcting said correction data based on said time-dependent amount of change; and
correcting the state in which the recording components are controlled, using the corrected correction data, and recording an image depending on said image data on said image recording medium.

2. A method according to claim 1, wherein said correction data comprise mask data for controlling particular ones of said recording components into an off-state for correcting a locality of the image recorded on said image recording medium.

3. A method according to claim 1, wherein a test pattern based on test data comprising a repetition of constant line widths and constant spaced widths is recorded on said image recording medium, and line widths or line intervals are measured at each position on said test pattern are measured to determine said correction data.

4. A method according to claim 1, wherein a test pattern based on test data of a constant density is recorded on said image recording medium, and densities in respective areas on said test pattern are measured to determine said correction data.

5. A method according to claim 1, wherein a halftone dot pattern is recorded on said image recording medium, and halftone dot % or densities in respective areas on said halftone dot pattern are measured to determine said correction data.

6. A method according to claim 1, wherein said correction data are established for each type of said image recording medium.

7. A method according to claim 1, wherein said image recording characteristic value comprises amounts of light of light beams modulated by said recording components depending on said image data, and said correction data are corrected based on said time-dependent amounts of change in said amounts of light and a relationship of amounts of change in amounts of light with respect to amounts of change in the image recorded on said image recording medium.

8. A method according to claim 1, wherein said image recording characteristic value comprises beam diameters of light beams modulated by said recording components depending on said image data, and said correction data are corrected based on said time-dependent amounts of change in said beam diameters and a relationship of amounts of change in amounts of light with respect to amounts of change in the image recorded on said image recording medium.

9. A method according to claim 1, wherein said image recording characteristic value comprises amounts of light and beam diameters of light beams modulated by said recording components depending on said image data, and said correction data are corrected based on said time-dependent amounts of change in said amounts of light and said beam diameters and a relationship of amounts of change in amounts of light with respect to amounts of change in the image recorded on said image recording medium.

10. An apparatus for recording an image on an image recording medium by controlling a plurality of recording components depending on image data, comprising:
correction data setting means for setting correction data for correcting a state in which the recording components are controlled by said image data;
correction data storage means for storing said correction data;
characteristic value measuring means for measuring an image recording characteristic value provided by said recording components;
amount-of-change calculating means for calculating a time-dependent amount of change in said image recording characteristic value;
correction data correcting means for correcting said correction data based on said time-dependent amount of change; and
recording component control means for correcting the state in which the recording components are controlled, using said correction data, and recording an image depending on said image data on said image recording medium.

11. An apparatus according to claim 10, wherein said image recording characteristic value comprises amounts of light of light beams modulated by said recording components depending on said image data.

12. An apparatus according to claim 10, wherein said image recording characteristic value comprises beam diameters of light beams modulated by said recording components depending on said image data.

13. An apparatus according to claim 10, wherein said image recording characteristic value comprises amounts of light and beam diameters of light beams modulated by said recording components depending on said image data.

14. An apparatus according to claim 11, further comprising amount-of-change storage means for storing a relationship between amounts of change in said amounts of light and amounts of change in the image recorded on said image recording medium, and said correction data correcting means converts said amounts of change in the image into amounts of change in the amounts of light of said light beams, and corrects said correction data based on the converted amounts of change in the amounts of light.

15. An apparatus according to claim 10, wherein said recording components make up a spatial light modulator for modulating a light beam depending on said image data and recording the image on said image recording medium by exposing said image recording medium to the modulated light beam.

16. An apparatus according to claim 15, wherein said spatial light modulator comprises a micromirror device including a two-dimensional array of micromirrors having reflecting surfaces for reflecting said light beam, said reflecting surfaces being angularly variable depending on said image data.

17. A method of recording an image on an image recording medium by controlling a plurality of recording components depending on image data, comprising the steps of:
measuring an image recording characteristic value provided by said recording components;
setting correction data for correcting a state in which the recording components are controlled by said image data, in view of a time-depending change in said image recording characteristic value; and
correcting the state in which the recording components are controlled, using the correction data, and recording an image depending on said image data on said image recording medium.

18. A method according to claim 17, wherein said correction data comprise mask data for controlling particular ones of said recording components into an off-state for correcting a locality of the image recorded on said image recording medium.

19. A method according to claim 17, wherein said correction data are established for each type of said image recording medium.

20. A method according to claim 17, wherein said image recording characteristic value comprises amounts of light of light beams modulated by said recording components depending on said image data, and said correction data are determined based on a relationship between said time-dependent amounts of change in said amounts of light and changes in the image recorded on said image recording medium.

21. A method according to claim 17, wherein said image recording characteristic value comprises beam diameters of light beams modulated by said recording components depending on said image data, and said correction data are determined based on a relationship between said time-dependent amounts of change in said beam diameters and changes in the image recorded on said image recording medium.

22. A method according to claim 17, wherein said image recording characteristic value comprises amounts of light and beam diameters of light beams modulated by said recording components depending on said image data, and said correction data are determined based on a relationship between said time-dependent amounts of change in said amounts of light and said beam diameters and changes in the image recorded on said image recording medium.
